(19) United States
(12) Patent Application Publication
(10) Pub. No.: US 2026/0002328 A1
(43) Pub. Date: Jan. 1, 2026

(54) Enhancing Oil Recovery and Evaporation from Evaporation Ponds

(71) Applicant: Saudi Arabian Oil Company, Dhahran (SA)

(72) Inventors: Maher Alerwi Alerwi, Dhahran (SA); Abdulrahman Mohammed Alqahtani, Khobar (SA); Abdoulelah Naji Hannabi, Mubarraz (SA); Christian Canto Maya, Dhahran (SA); Faris Mohammad Alzamanan, Dhahran (SA)

(21) Appl. No.: 18/761,019

(22) Filed: Jul. 1, 2024

(51) Int. Cl. E02B 15/04; B01D 1/14; B01D 17/02; B01F 23/232; B01F 23/237; B01F 101/00; C02F 1/04; C02F 1/14; C02F 1/40; C02F 101/32; C02F 103/10

(52) U.S. Cl. CPC E02B 15/045; B01D 1/14; B01D 17/0214; B01F 23/232; B01F 23/237611; C02F 1/048; C02F 1/14; C02F 1/40; B01F 2101/305; C02F 2101/32; C02F 2103/10; C02F 2201/009

(57) ABSTRACT

Systems and methods can be used in removing oil from evaporation ponds. The systems system comprising: a body with an outer wall and an inner wall connected by a floor, the outer wall, the inner wall, and the floor defining a reservoir, the body having an outlet positioned within the inner wall; one or more floats coupled to the body, the one or more floats sized such that the floating subsystem has a buoyancy which aligns a waterline of the body with a top of the outer wall; a fan mounted on the body; and a plurality of conduits, each conduit extending from the fan to a position outside the outer wall of the body below the waterline of the system.

### TECHNICAL FIELD

This specification generally relates to wastewater treatment in the oil and gas sector, particularly using evaporation ponds.

### BACKGROUND

Evaporation ponds are artificial ponds optimized for water evaporation, leveraging sunlight and ambient temperatures. Their design is primarily based on a large surface area, making them highly suitable for applications like wastewater treatment, especially in the oil and gas industry. The location of these ponds is fundamental for their efficiency, with regions boasting high solar radiation and high temperatures being ideal. These ponds are often shallow to enhance evaporation rates. They have a high surface area-to-volume ratio for faster evaporation. The management of produced water, which contains high total dissolved solids including salts, oil, grease, and various other compounds, is crucial in oil production. After significant evaporation, a concentrated salt sludge remains, which is either retained, disposed of, or recycled.

### SUMMARY

This specification describes approaches to increasing the evaporation rates from an evaporation pond by removing and disrupting an oil layer on the pond surface that can inhibit evaporation. These approaches agitate the oil layer and help provide consistent airflow above the pond. In addition to accelerating evaporation, some implementations of these approaches also reclaim valuable oil for reuse, presenting a sustainable and economically beneficial solution. These implementations typically use systems that can operate in two modes: a passive collection mode and an active agitation and aeration mode. Typically, the system operates in passive collection mode when the oil layer on the pond surface is relatively thick and stable, allowing for efficient passive collection of oil. The active agitation and aeration mode is triggered when the oil layer becomes too thin for effective passive collection, or when environmental conditions (e.g., low wind speed, high humidity) reduce natural evaporation rates, requiring additional agitation and aeration to enhance evaporation.

The approaches disclosed in this specification can be used to provide one or more of the following advantages. Removing and/or disrupting oil layers on top of water in evaporation ponds increase the access by the water to sunlight and ambient temperatures, which in turn enhances the natural evaporation cycle. In addition, these approaches can provide air movement above evaporation ponds reducing the likelihood that the air above the pond is still and stagnant. By helping move air saturated with water vapor away from the ponds, this can increase the potential for more water to evaporate from the pond. In some instances, these approaches can also reduce atmospheric emissions and potential water contamination from hydrocarbons in produced water.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view illustrating an oil rig, evaporation ponds, and a system for enhancing oil recovery and evaporation from evaporation ponds.

FIGS. 2A-2C are more detailed views of a portion of the illustrate an example system used to implement processes for system for enhancing oil recovery and evaporation from evaporation ponds.

FIG. 3 is a flow chart illustrating a method of enhancing oil recovery and evaporation from evaporation ponds.

FIG. 4 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and method for increasing evaporation rates from an evaporation pond by removing and disrupting an oil layer on the pond surface that can inhibit evaporation. These approaches agitate the oil layer and help provide consistent airflow above the pond. In addition to accelerating evaporation, some implementations of these approaches also reclaim valuable oil for reuse, presenting a sustainable and economically beneficial solution. These implementations typically use systems that can operate in two modes: a passive collection mode and an active agitation and aeration mode. Typically, the system operates in passive collection mode when the oil layer on the pond surface is relatively thick and stable, allowing for efficient passive collection of oil. The active agitation and aeration mode is triggered when the oil layer becomes too thin for effective passive collection, or when environmental conditions (e.g., low wind speed, high humidity) reduce natural evaporation rates, requiring additional agitation and aeration to enhance evaporation.

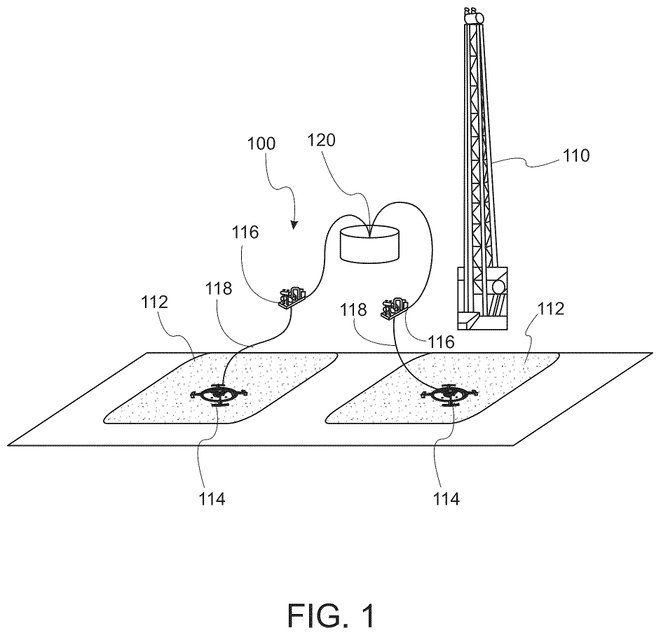

FIG. 1 is a schematic view illustrating an a system 100 for enhancing oil recovery and evaporation from evaporation ponds, an oil rig 110, and two evaporation ponds 112. During production, produced water generated by the oil rig 110 is discharged into the evaporation ponds 112. After entering the evaporation ponds 112, the produced water separates with oil rising to the surface and forming and an oil layer above a water layer. Solids in the produced water settle to the bottom of the ponds and/or are concentrated as water evaporates from the ponds.

The system 100 for enhancing oil recovery and evaporation from evaporation ponds includes floating subsystems 114, pumps 116, and hoses 118 extending from the floating subsystems 114 to the pumps 116. The pumps 116 are operable to transfer reclaimed oil from the floating subsystems 114 to storage or back into production operations. In the system 100, the pumps 116 transfer reclaimed oil to a storage tank 120. The pumps and hoses should be resistant to corrosion and chemical degradation due to prolonged exposure to the high salinity and chemical composition of produced water. Additionally, the hoses should be flexible and durable, capable of withstanding various weather conditions and physical stresses without compromising the efficiency of oil transfer.

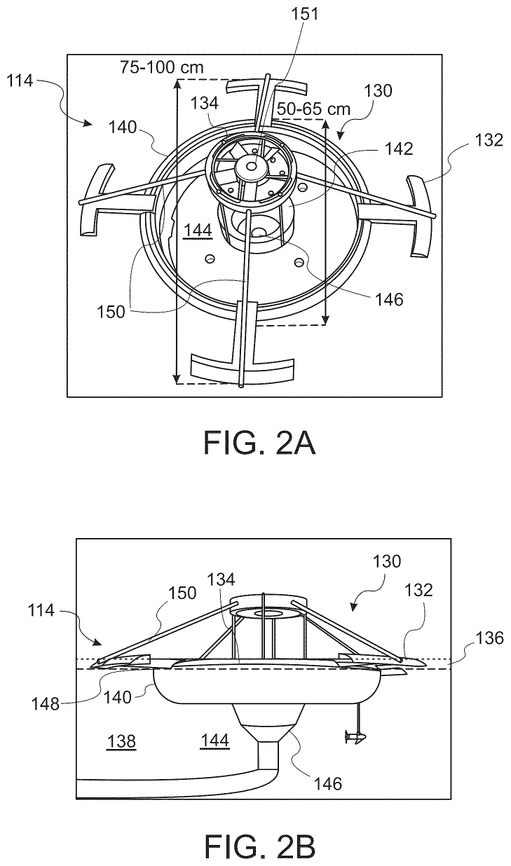

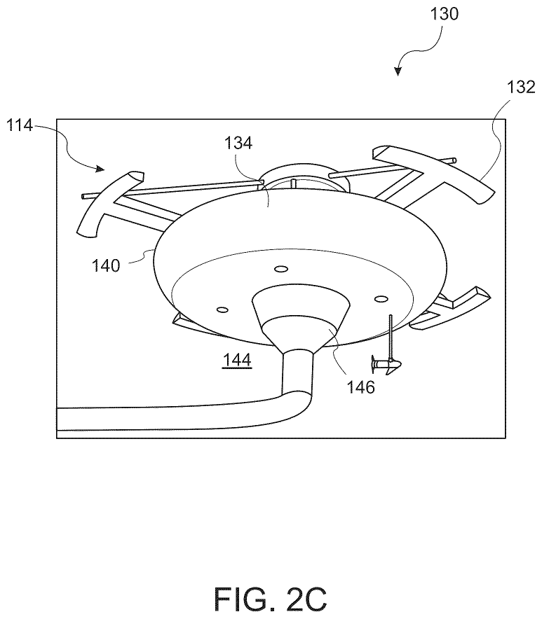

FIGS. 2A-2C are more detailed views of one of the floating subsystems 114. The floating subsystem 114 includes a body 130, one or more floats 132, and a fan 134. A control system with at least one processor is coupled to the fan 134 and the pump 116 and operable to control the fan 134 and the pump 116. The control system can be programmed to operate the system autonomously and/or can be operated by remote control.

The body 130 is configured to collect oil from an oil layer 136 floating on the surface of a water layer 138 in an evaporation pond 112. The body 130 of the illustrated floating subsystem 114 has an outer wall 140 and an inner wall 142 connected by a floor 144. The outer wall 140, the inner wall 142, and the floor 144 define a reservoir that passively collects oil when the floating subsystem 114 is deployed in an evaporation pond 112. The floor defines holes extending through the floor from the reservoir. The outer wall 140 limits the flow of water into the reservoir while allowing oil floating the water to pass. In addition, the holes extending through the floor from the reservoir allows water passing the outer wall 140 to return to the evaporation pond 112 increasing the oil concentration in the reservoir.

The body 130 has an outlet 146 positioned within the inner wall 142. The inner wall 142, located centrally within the outer wall 140 and reservoir, acts as a secondary separator, filtering only the topmost layer of the fluid in the reservoir. The outlet provides a channel through collected oil can be extracted. Although the outlet 146 of the floating subsystem 114 has a generally funnel-shaped configuration, some bodies have other outlet shapes.

Some implementations include a filter (e.g., a wire mesh) filtering fluid flowing to the outlet to exclude solid contaminants. For example, the outlet of the floating subsystem includes a wire mesh extending across opening defined by the inner wall 142. Not all implementations include a filter.

The one or more floats 132 are coupled to the body 130 such that the floating subsystem 114 has a buoyancy which aligns a waterline 148 of the body 130 with a top of the outer wall 140. The waterline of the body 130 indicates the line formed by the surface of the water layer in the pond 112 on the body 130 of a deployed floating subsystem 114. The position of the waterline 148 on the body 130 is determined by the balance between the weight of the floating subsystem 130 and the density and volume of fluid displaced by the floating subsystem. The balance can be calculated using a default water density used can be 1.03 g/cm³, corresponding to the typical density of produced water with high salinity. Adjustable floats can be used to accommodate variations in water density and ensure the system remains properly aligned with the water surface. The waterline 148 is considered to be aligned with the top of the outer wall 140 if the waterline 148 is within ±2 centimeters of the top of the outer wall 140. This allows the system to operate efficiently while accounting for minor fluctuations in water level and surface conditions.

The fan 134 is also mounted on the body 130 and serves the purposes of aerating the pond surface and of pushing air into the pond 112 via conduits 150 (e.g., air pipes) to disrupt the oil layer. The fan 134 has a housing with a side wall. A floor extends across one side of a cavity defined by the side wall and the opposite side of the cavity is open. The floor of the housing of the fan 134 defines holes that extend through the floor from the cavity. These holes allow air to go through the floor of the fan housing.

The housing mounted in a fixed position relative to the body 130. In the floating subsystem, the four rods extend between the body 130 and the housing of the fan 134 but other approaches to coupling the body 130 and fan 134 are also feasible. The fan 134 has fan blades oriented to move air towards the body 130 when the fan 134 is operated in first mode with the blades rotating in a first direction. The system 100 has a fan that only rotates in the first direction. For this configuration, the fan 134 is off when the system 100 is in the passive collection mode. When the system 100 is in the an active agitation and aeration mode, the fan blows air downward. In this mode, some of the air goes through the air flow pipes to agitate the water surface and some of the air goes through the holes below the fan to move the air around the device. In some implementations, the fan 134 has a second mode with the blades rotating in a second direction opposite the first direction. For example, the fan 134 in such implementations can be operated in one direction to provide aeration/agitation of the oil layer and in the opposite direction to provide airflow away the pond 112 to move otherwise stagnant water-saturated air away from the evaporation pond 112.

A plurality of conduits extends from openings in the housing of the fan 134 to a position outside the outer wall 140 of the body 130 below the waterline 148 of the body 130. These conduits 150 channel air pushed towards the pond 112 by the fan 134 into the evaporation pond 112, creating bubbles that break up the oil layer. This positioning is provides air bubbles that can effectively agitate the water and the oil layer, facilitating the mixing and aeration to enhance evaporation rates. In the illustrated implementation, the conduits 150 are fastened at one end to the housing of the fan 134 and mounted on the floats 132 at the other end.

A power source 151 for the fan 134 and other components is coupled to the body 130. Typically, the power source includes one or more batteries. In the illustrated system, the batteries are augmented by solar cells which can recharge the batteries. Some systems use other power sources (e.g., a power line running along the hose used to recover oil from the outlet).

Some implementations of these systems include a propulsion system to control movement of the floating subsystems 114. For example, the illustrated the floating subsystems 114 includes a propeller coupled to the body 130. The propeller is driven by an electrical motor (not shown). The propeller is mounted to the body 130 using a rotatable shaft and the direction of motion applied by the propeller is controlled by the direction the propeller is oriented by the shaft. The propeller system allows the floating subsystem 114 to navigate across the surface for desired positioning and efficiency. It can be controlled remotely or programmed to follow a specific path, ensuring even coverage and effectiveness across the pond 112. The propellers would be powered by the system's energy source (e.g., batteries or solar power) and integrated with the control system to coordinate movement with the operational modes of oil recovery and water agitation/aeration.

The floating subsystem 114 has a generally circular shape. The specific dimensions will depend on the application scale with detailed dimensions based on engineering analysis for specific pond sizes and conditions. The nominal outer diameter Ds (i.e., from the outer edge of one float 132 to the outer edge of an opposite float 132) for most systems is anticipated to be between 75 and 100 centimeters. The diameter of the outer wall 140 Dow for most systems is anticipated to be between 50 and 65 centimeters. A single floating subsystem is anticipated to cover an area of approximately 50-1000 square meters, depending on the specific design and environmental conditions

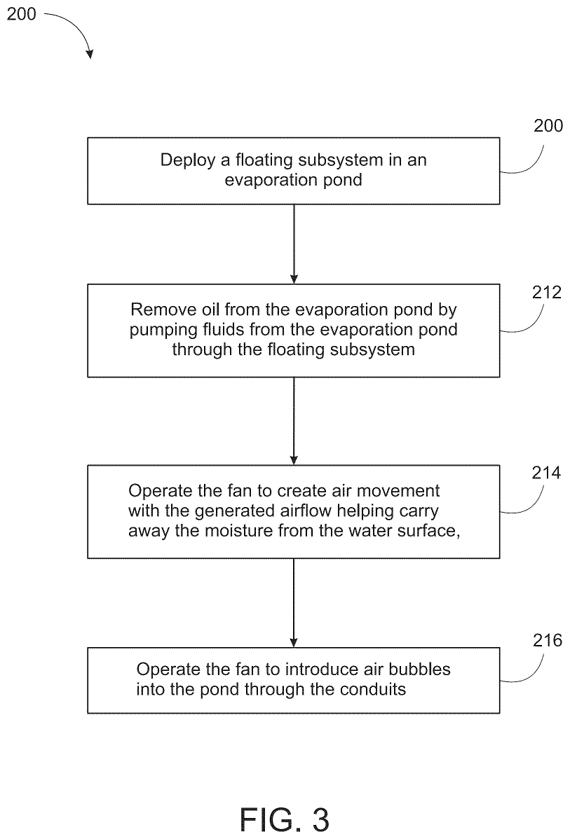

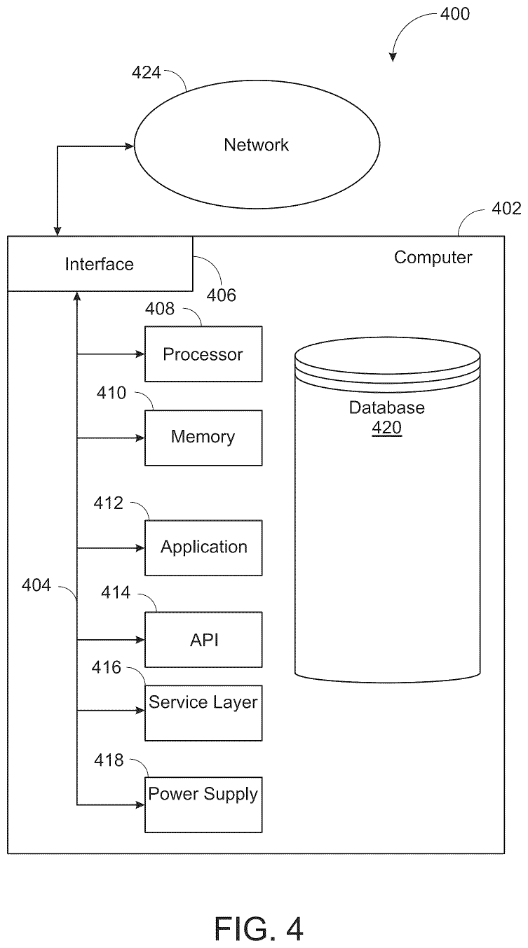

FIG. 3 is a flow chart illustrating a method 200 of enhancing oil recovery and evaporation from evaporation ponds. The method 200 can be performed using the system 100 described with respect to FIGS. 1-2C but can also be performed using other systems. The method 200 is described with reference numbers of the components of the system 100.

A floating subsystem 114 is deployed to an evaporation pond 112 (step 210). The system has modes of operation that include an oil collection mode, an agitation mode, and an aeration mode. The operator can change between modes of operation or automate the process by choosing when each mode should start or stop. Although the method 200 is described with the modes of operation used sequentially, the method 200 can be performed with the modes c of operation used in different orders.

The oil collection mode remove oil from the evaporation pond 112 by pumping fluids from the evaporation pond 112 through the floating subsystem 114 (step 212). The oil collection mode works by controlling the inlet and outlet flow of oil and water through the system and relying on the density difference between oil and water to achieve separation. The pumping rate of the pump 116 connected to the outlet of the floating subsystem 114 controls the flow rate into the outer collector and flow rate through both inner collector. By adjusting the flow rate of the inlet into the outer collector and outlet flow rate throughout both inner collector and placed holes at the bottom, system can control the residence time of the mixture in the separation collector, allowing for better separation. Lower flow rates generally result in improved separation as they provide more time for the oil and water to settle and separate naturally.

The agitation mode and aeration mode are based on use of the fan 134. The agitation mode uses the fan 134 to create air movement with the generated airflow helping carry away the moisture from the water surface, facilitating faster evaporation (step 214). In contrast, the aeration mode increases evaporation rates by introducing air bubbles into the pond 112 through the conduits 150 (step 216). This approach promotes mixing and enhances the contact between the water surface and the air, which will increase the surface area and aid in accelerating evaporation.

In effect, this approach invention increases the evaporation rate of the water by three means. It collects the oil from the pond 112 surface to reduce barrier to evaporation at the top of the pond and to decrease the environmental impact of the oil. It introduces agitation of the top layer to increase the contact serves area of the water with the surrounding air. It introduces air flow above the evaporation pond 112 to carry away the moisture from the water surface, facilitating faster evaporation

FIG. 4 is a block diagram of an example data processing system 400 used to provide computational functionalities associated with described algorithms, methods, functions, processes, flows, and procedures described in the present disclosure. For example, the data processing system 400 can be configured for operation of components of systems for enhancing oil recovery and evaporation from evaporation ponds. The data processing device 402 can include input devices such as keypads, keyboards, and touch screens that can accept user information. Also, the data processing device 402 can include output devices that can convey information associated with the operation of the data processing device 402. The information can include digital data, visual data, audio information, or a combination of information. The information can be presented in a graphical user interface (UI) (or GUI).

The data processing device 402 can serve in a role as a client, a network component, a server, a database, a persistency, or components of a computer system for performing the subject matter described in the present disclosure. The illustrated data processing device 402 is communicably coupled with a network 424. In some implementations, one or more components of the data processing device 402 can be configured to operate within different environments, including cloud-computing-based environments, local environments, global environments, and combinations of environments.

The data processing device 402 can receive requests over network 424 from a client application (for example, executing on another data processing device 402). The data processing device 402 can respond to the received requests by processing the received requests using software applications. Requests can also be sent to the data processing device 402 from internal users (for example, from a command console), external (or third) parties, automated applications, entities, individuals, systems, and computers.

Each of the components of the data processing device 402 can communicate using a system bus 404. In some implementations, any or all of the components of the data processing device 402, including hardware or software components, can interface with each other or the interface 406 (or a combination of both), over the system bus 404. Interfaces can use an application programming interface (API) 414, a service layer 416, or a combination of the API 414 and service layer 416. The API 414 can include specifications for routines, data structures, and object classes. The API 414 can be either computer-language independent or dependent. The API 414 can refer to a complete interface, a single function, or a set of APIs.

The service layer 416 can provide software services to the data processing device 402 and other components (whether illustrated or not) that are communicably coupled to the data processing device 402. The functionality of the data processing device 402 can be accessible for all service consumers using this service layer. Software services, such as those provided by the service layer 416, can provide reusable, defined functionalities through a defined interface. For example, the interface can be software written in JAVA, C++, or a language providing data in extensible markup language (XML) format. While illustrated as an integrated component of the data processing device 402, in alternative implementations, the API 414 or the service layer 416 can be stand-alone components in relation to other components of the data processing device 402 and other components communicably coupled to the data processing device 402. Moreover, any or all parts of the API 414 or the service layer 416 can be implemented as child or sub-modules of another software module, enterprise application, or hardware module without departing from the scope of the present disclosure.

The data processing device 402 includes an interface 406. Although illustrated as a single interface 406 in FIG. 4, two or more interfaces 406 can be used according to implementations of the data processing device 402 and the described functionality. The interface 406 can be used by the data processing device 402 for communicating with other systems that are connected to the network 424 (whether illustrated or not) in a distributed environment. Generally, the interface 406 can include, or be implemented using, logic encoded in software or hardware (or a combination of software and hardware) operable to communicate with the network 424. More specifically, the interface 406 can include software supporting one or more communication protocols associated with communications. As such, the network 424 or the interface's hardware can be operable to communicate physical signals within and outside of the illustrated data processing device 402.

The data processing device 402 includes a processor 408. Although illustrated as a single processor 408 in FIG. 4, two or more processors 408 can be used according to implementations of the data processing device 402 and the described functionality. Generally, the processor 408 can execute instructions and can manipulate data to perform the operations of the data processing device 402, including operations using algorithms, methods, functions, processes, flows, and procedures as described in the present disclosure.

The data processing device 402 also includes a database 420 that can hold data (such as pump and fan operating parameters) for the data processing device 402 and other components connected to the network 424 (whether illustrated or not). For example, database 420 can be in-memory or a database storing data consistent with the present disclosure. In some implementations, database 420 can be a combination of two or more different database types (for example, hybrid in-memory and conventional databases) according to implementations of the data processing device 402 and the described functionality. While database 420 is illustrated as an internal component of the data processing device 402, in alternative implementations, database 420 can be external to the data processing device 402.

The data processing device 402 also includes a memory 410 that can hold data for the data processing device 402 or a combination of components connected to the network 424 (whether illustrated or not). In some implementations, memory 410 can be a combination of two or more different types of memory (for example, a combination of semiconductor and magnetic storage) according to implementations of the data processing device 402 and the described functionality. While memory 410 is illustrated as an internal component of the data processing device 402, in alternative implementations, memory 410 can be external to the data processing device 402.

The application 412 can be an algorithmic software engine providing functionality according to implementations of the data processing device 402 and the described functionality. For example, application 412 can serve as one or more components, modules, or applications.

The data processing device 402 can also include a power supply 418. The power supply 418 can include a rechargeable or non-rechargeable battery that can be configured to be either user-or non-user-replaceable.

There can be any number of computers 402 associated with, or external to, a computer system including the data processing device 402, with each data processing device 402 communicating over network 424. Further, the terms “client,” “user,” and other appropriate terminology can be used interchangeably, as appropriate, without departing from the scope of the present disclosure. Moreover, the present disclosure contemplates that many users can use one data processing device 402 and one user can use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware- and software-based).

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random-access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

### EXAMPLES

In some implementations, systems for use in removing oil from evaporation ponds include a body with an outer wall and an inner wall connected by a floor, the outer wall, the inner wall, and the floor defining a reservoir, the body having an outlet positioned within the inner wall; one or more floats coupled to the body, the one or more floats sized such that the floating subsystem has a buoyancy which aligns a waterline of the body with a top of the outer wall; a fan mounted on the body; and a plurality of conduits, each conduit extending from the fan to a position outside the outer wall of the body below the waterline of the system.

In an example implementation combinable with any other example implementation, the floor defines holes extending through the floor from the reservoir.

In an example implementation combinable with any other example implementation, the fan having fan blades oriented to move air towards the body when the fan is operated in first mode with the blades rotating in a first direction. In some cases, the fan has a second mode with the blades rotating in a second direction opposite the first direction.

In an example implementation combinable with any other example implementation, a net is attached to the inner wall positioned to filter fluids flowing through the outlet of the body.

In an example implementation combinable with any other example implementation, the system also includes at least processor coupled to the fan and operable to control the fan.

In an example implementation combinable with any other example implementation, the system also includes at least one propeller coupled to the body.

In an example implementation combinable with any other example implementation, the system also includes a power source coupled to the body. In some cases, the power source comprises one or more batteries. In some cases, the power source comprises at least one solar cell.

In an example implementation combinable with any other example implementation, the system also includes a pump and a hose extending between the outlet of the body and the pump. In some cases, the system also includes at least processor coupled to the fan and the pump, the at least one processor operable to control the fan and the pump.

In some implementations, methods for use in removing oil from evaporation ponds include: deploying a floating subsystem on a surface of the an evaporation pond, the floating subsystem comprising a fan and conduits; removing oil from the evaporation pond by pumping fluids from the evaporation pond through the floating subsystem; operating the fan to create air movement with the generated airflow helping carry away the moisture from the surface of the evaporation pond; and operating the fan to introduce air bubbles into the pond through the conduits.

In an example implementation combinable with any other example implementation, the floating subsystem also includes: a body with an outer wall and an inner wall connected by a floor, the outer wall, the inner wall, and the floor defining a reservoir, the body having an outlet positioned within the inner wall; and one or more floats coupled to the body, the one or more floats sized such that the floating subsystem has a buoyancy which aligns a waterline of the body with a top of the outer wall.

In an example implementation combinable with any other example implementation, the method also includes switching the floating subsystem from a passive collection mode and an active agitation and aeration mode. In some cases, the fan is off when the floating subsystem is in the passive collection mode. In some cases, the fan is on when the floating subsystem is in the active agitation and aeration mode. In some cases, the fan blows air downwards when the fan is on.

A number of embodiments of the systems and methods have been described. Nevertheless, it will be understood that various modifications may be made without departing from the spirit and scope of this specification. Accordingly, other embodiments are within the scope of the following claims.

What is claimed is:

1. A system for use in removing oil from evaporation ponds, the system comprising:
a body with an outer wall and an inner wall connected by a floor, the outer wall, the inner wall, and the floor defining a reservoir, the body having an outlet positioned within the inner wall;
one or more floats coupled to the body, the one or more floats sized such that the floating subsystem has a buoyancy which aligns a waterline of the body with a top of the outer wall;
a fan mounted on the body; and
a plurality of conduits, each conduit extending from the fan to a position outside the outer wall of the body below the waterline of the system.

2. The system of claim 1, wherein the floor defines holes extending through the floor from the reservoir.

3. The system of claim 1, wherein the fan has fan blades oriented to move air towards the body when the fan is operated in first mode with the blades rotating in a first direction.

4. The system of claim 3, wherein the fan has a second mode with the blades rotating in a second direction opposite the first direction.

5. The system of claim 1, further comprising a net attached to the inner wall positioned to filter fluids flowing through the outlet of the body.

6. The system of claim 1, at least processor coupled to the fan and operable to control the fan.

7. The system of claim 1, further comprising at least one propeller coupled to the body.

8. The system of claim 1, further comprising a power source coupled to the body.

9. The system of claim 8, wherein the power source comprises one or more batteries.

10. The system of claim 8, wherein the power source comprises at least one solar cell.

11. The system of claim 1, further comprising a pump and a hose extending between the outlet of the body and the pump.

12. The system of claim 11, at least processor coupled to the fan and the pump, the at least one processor operable to control the fan and the pump.

13. A method of removing oil from an evaporation pond, the method comprising:
deploying a floating subsystem on a surface of the an evaporation pond, the floating subsystem comprising a fan and conduits;
removing oil from the evaporation pond by pumping fluids from the evaporation pond through the floating subsystem;
operating the fan to create air movement with the generated airflow helping carry away the moisture from the surface of the evaporation pond; and
operating the fan to introduce air bubbles into the pond through the conduits.

14. The method of claim 13, wherein the floating subsystem further comprises:
a body with an outer wall and an inner wall connected by a floor, the outer wall, the inner wall, and the floor defining a reservoir, the body having an outlet positioned within the inner wall; and
one or more floats coupled to the body, the one or more floats sized such that the floating subsystem has a buoyancy which aligns a waterline of the body with a top of the outer wall.

15. The method of claim 13, wherein the method comprises switching the floating subsystem from a passive collection mode and an active agitation and aeration mode.

16. The method of claim 15, wherein the fan is off when the floating subsystem is in the passive collection mode.

17. The method of claim 16, wherein the fan is on when the floating subsystem is in the active agitation and aeration mode.

18. The method of claim 17, wherein the fan blows air downwards when the fan is on.
